(19) United States
(12) Patent Application Publication
(10) Pub. No.: US 2007/0023446 A1
(43) Pub. Date: Feb. 1, 2007

(54) Device of storing cutlery

(76) Inventors: Yung Li Kuo, Taipei County (TW); Chun Lung Huang, Taipei County (TW); Wen Pao Lin, Taipei County (TW)

Correspondence Address: Yung Li Kuo, 3620 168th St., apt 3D, Flushing, NY, 11358, US

(21) Appl. No.: 11/192,767

(22) Filed: Aug. 1, 2005

(51) Int. Cl. B23Q 7/04

(52) U.S. Cl. 221/211

(57) ABSTRACT

It is an object of the present invention to provide a device that can comprise a plurality of cutlery, the device comprises space in a holder that can store disposable cutlery, a moving device such as a connecting stand is formed on the holder. A pressing shaft is formed on a central portion of the connecting stand, and when the pressing shaft is pushed down, a first sucking plate of the device will be triggered to push open a cover body of the device automatically and draws in the cutlery so that the user can retrieve the cutlery easily. Once the disposable cutlery are taken out, the cover body will close automatically so that the cutlery located side the device can be hygienic kept.

### BACKGROUND OF THE INVENTION

1. Field of Invention

The present invention relates generally to a structure of a device drawing in cutlery and storing them. More particularly, the present invention relates to a device that keeps hygienic cutlery by opening automatically its cover body to allow the user to take out the clear cutlery before closing automatically the cover body of the device so that the cutlery can be kept clear.

2. Description of the Related Art

Present-day society increasingly relies on disposable cutlery, with the increasing demands of disposable cutlery in the daily life, the utility and the storage of the disposable cutlery become very important, more particularly, the hygiene of cutlery. In the current situation, most of the disposable cutlery that are utilized in the small restaurants, night markets, traditional markets and hawkers are kept in an open area for easily retrieved and utilization. But it also means that those cutlery are exposed to the unseen bacteria and flies, dust and pollutants. Most customers will not wash those disposable cutlery before utilizing in the restaurants, therefore, most the bacteria will be eaten into the bodies of the customers causing the infections or diseases on the consumers. Moreover, contagious diseases such flu, can transmit through the human direct contact with or proximity to an infected individual with the cutlery to spread the disease from one person to the others. Thus, it is dangerous to keep those cutlery in the open area without any protection before utilizing by the consumers. It is one of the object of the present invention to provide a device that can store and keep those disposable cutlery in a hygienic storage.

### SUMMARY OF THE INVENTION

It is an object of the present invention to provide a device that can comprise a plurality of cutlery, and when a pressing shaft is pushed down, a first sucking plate of the device will be triggered to push open a cover body of the device automatically and draws in the cutlery so that the user can retrieve the cutlery easily. Once the cutlery are taken out, the cover body will close automatically so that the cutlery located side the device can be hygienic kept.

In order to achieve the above-mentioned objects, the present invention provides a device of drawing in cutlery, wherein the device comprises a holder located inside the device for resorting various cutlery and a connecting stand located on a top part of the device. A pressing shaft is located on a central part of the device, and a cover body is positioned on one side of the connecting stand and the top part of the device. A stand unit is located at a bottom portion of the device, and a movable device is designed between the holder and the connecting stand. A flexible device is formed between the pressing shaft and the connecting stand, and a first sucking plate is located at one end of the device.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings

FIG. 1 shows a prospective 3-D view of a device of drawing cutlery in accordance with a preferred embodiment of the present invention.

FIG. 2 illustrates an assembled view of the device of drawing cutlery in accordance with the preferred embodiment of the present invention.

FIG. 3 shows an assembled view of a top portion of the device of drawing cutlery in accordance with the preferred embodiment of the present invention.

FIG. 4 shows an assembled view of a bottom portion of the device of drawing cutlery in accordance with the preferred embodiment of the present invention.

FIG. 5 illustrates a diagram of showing how the device of drawing cutlery is utilized by opening a cover body automatically in accordance with a preferred example.

FIG. 6 illustrates a diagram of showing how the device of drawing cutlery is utilized by removing the top portion of the device in accordance with another preferred example.

FIG. 7 shows a cross-sectional view of one of designs of a device of drawing cutlery of a preferred embodiment of the present invention.

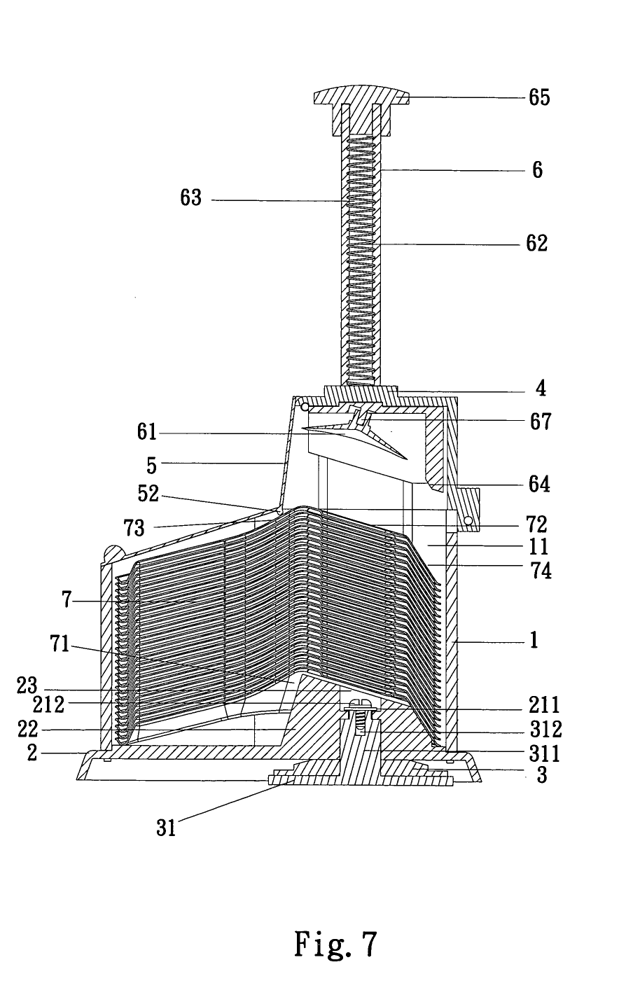

FIG. 8 illustrates another cross-sectional view of another designs of a device of drawing cutlery of another preferred embodiment of the present invention.

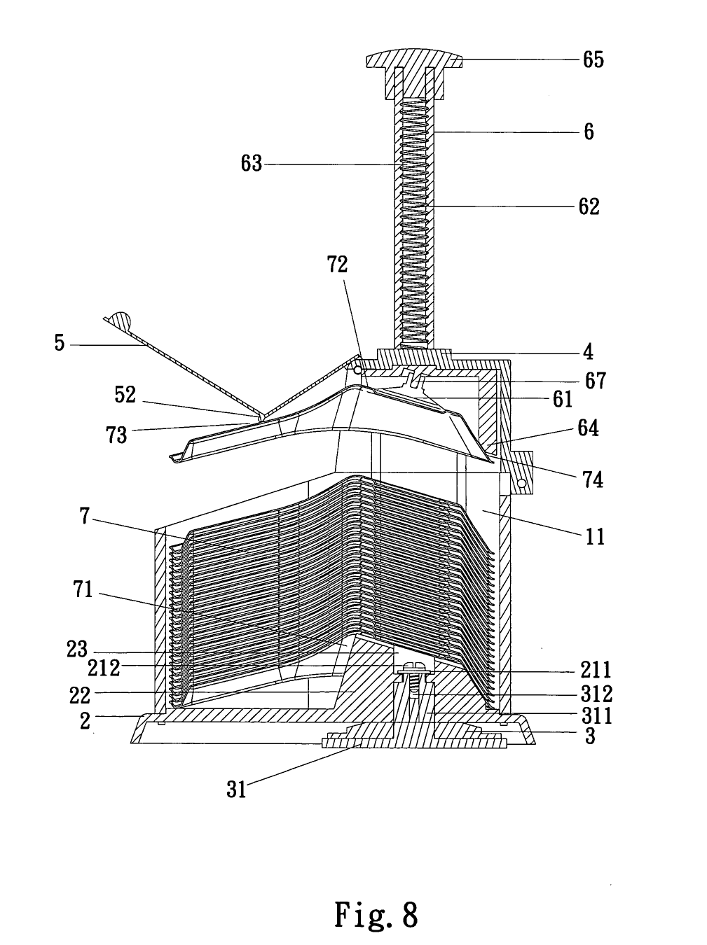

### DETAILED DESCRIPTION OF THE PREFERRED EMBODIMENTS

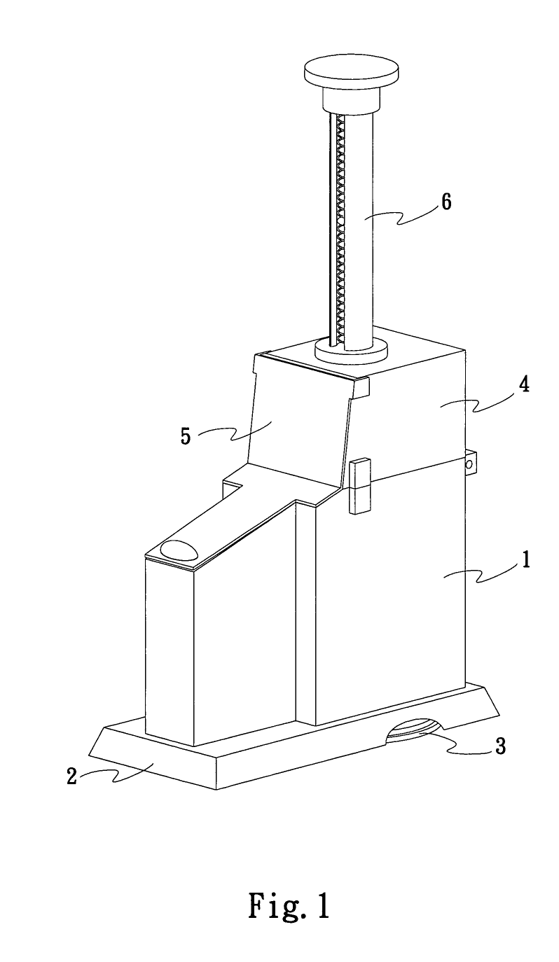

The present invention provides a device of drawing cutlery, such as teaspoons, small plates or bowls, forks or disposable spoons. Refer to FIG. 1, shows a prospective 3-D view of a device of drawing cutlery in accordance with a preferred embodiment of the present invention. Disposable spoons are used as an example to explain the main characteristics of the present invention. It is important to take note that the present invention is not limited to one particular type of cutlery such as disposable spoons, other cutlery, metal forks for example can be utilized as well. The device of drawing cutlery comprises a holder 1, a stand unit 2, a rotating unit 3, a connecting stand 4, a cover body 5 and a pressing shaft 6, wherein a plurality of cutlery can be placed inside the holder 1. When the pressing shaft 6 is pressed down, a first sucking plate located at one end of the pressing shaft 6 is triggered to push open the cover body and release those spoons to users. The objective of opening the cover body of the device automatically is achieved without hand-operating. Once the spoon/cutlery is taken out, the cover body 5 will be automatically closed up so that those cutlery can be kept hygienically.

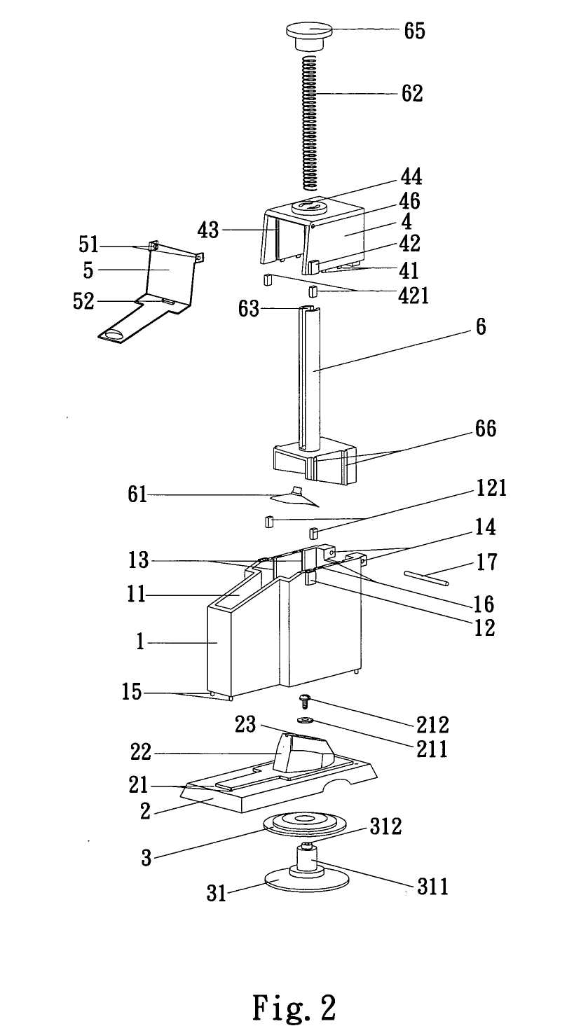

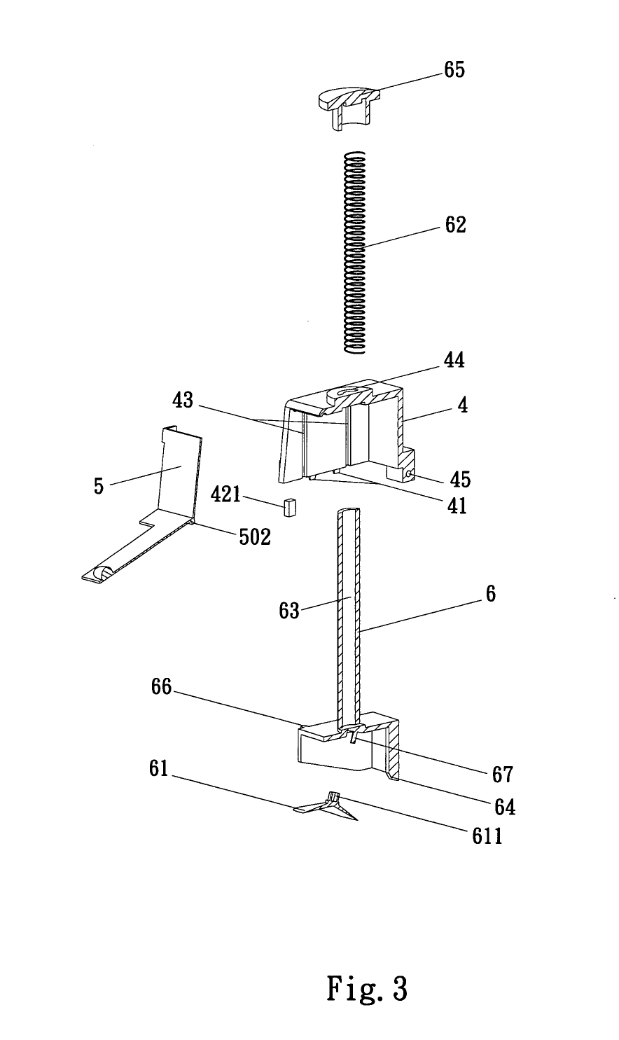

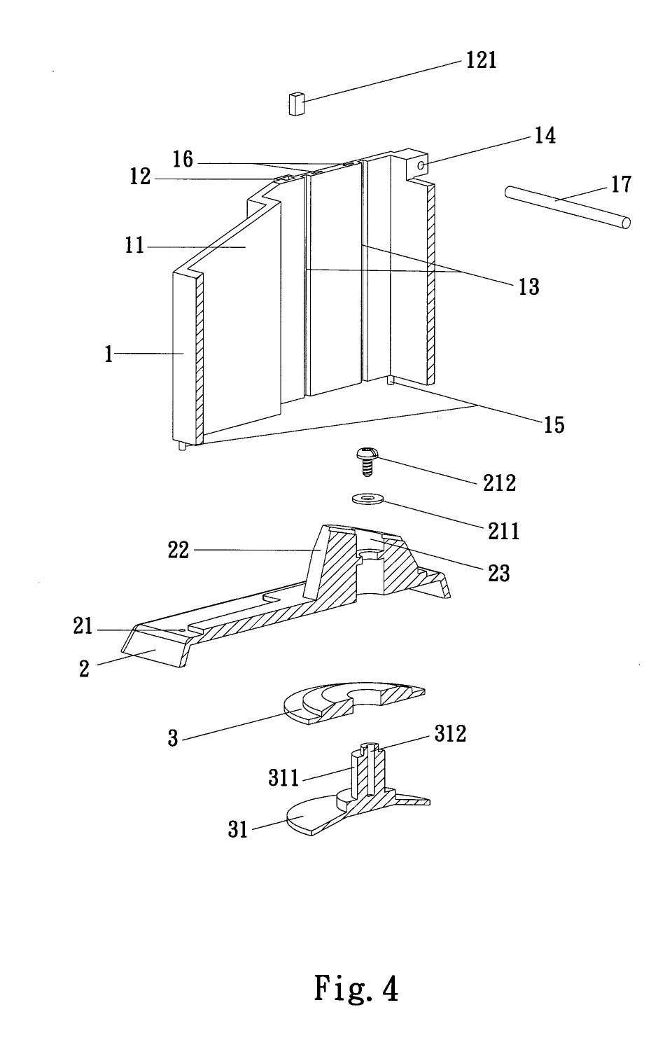

Refer to FIGS. 2, 3 and 4, illustrate the diagrams of an assembled view of the device of drawing cutlery in accordance with the preferred embodiment of the present invention, an assembled view of a top portion of the device of drawing cutlery, and an assembled view of a bottom portion of the device of drawing cutlery in accordance with the preferred embodiment of the present invention. A storing space 11 inside the holder 1 of the device can be stored a plurality of disposable spoons or cutlery 7, and bottom ends of scoops 71 of the disposable spoons 7 are inserted and fixed onto a protruding body 22 of a central part of the stand unit 2. At least one supporting protrusion is formed on a bottom portion of the holder 1 and is integrated with a fixing hole 21 of the stand unit 2 in order to stabilize the device 1 and the stand unit 2. A locating hole 23 is formed on the central part of the protruding body 22 of the stand 2, wherein a sucking shaft 311 in inserted into a central portion of a second sucking plate 31, and a plate 211 is located inside the locating hole 23. A fixing unit 212 is utilized to locate fixedly into a screw hole 312 of the sucking shaft 311 so that the rotating unit 3 is positioned firmly on the sucking shaft 311. At least one fixing slot 16 and a magnet slot 12 are formed on both sides of the holder 1, wherein a magnet 121 is located inside the magnet slot 12 and a locating hole 14 is formed on a top portion of a back side of the holder 1. A connecting shaft 17 is inserted through the locating hole 14 and a fixing slot 45 located on a bottom portion of a back side of the connecting stand 4 so that the holder 1 and the connecting stand 4 are connected freely to allow a rotated movement. Pressing guiding holes 44 are formed on a top portion of the connecting stand 4 to allow the pressing shaft 6 passing through the pressing guiding holes 44 so that the pressing shaft 6 can move up and down steadily along the pressing guiding holes 44. At least one ironic slot 42 and a plurality of positioning protrusions 41 are formed on both sides of the bottom portion of connecting stand 4, and a magnet plate 421 is inserted into the ironic slot 42. By utilizing the magnetic attraction force between the magnet plate 421 and the magnet 121 to allow the ironic slot 42 inserted into the fixing slot 16 so that the connecting stand 4 is stabilized. Thus, the holder 1 and the connecting stand 4 is sealed up. Cover fixing holes 46 are formed on both sides of a front section of the top portion of the connecting stand 4 in order to integrate to the cover protrusions 51 locating on both sides of a back section of the top portion of the cover body 5. There is a weight block located in a front end of the cover body 5 and protruding bars 66 are formed on both sides of a bottom part of the pressing shaft 6. The design of the protruding bars 66 is to allow the pressing shaft 6 to slide up and down steadily between trenches 43 locating on both sides of the connecting stand 4 and the holder channels 13 locating on both sides of the holder 1. A pressing protruding point 64 is formed on one end of a bottom part of the pressing shaft 6, and a fixing channel 67 is formed on a middle section of the bottom part of the pressing shaft 6. The fixing channel 67 is utilized to connect to a first sucking position hole 611 locating on the top portion of the first sucking plate 61. A hollow bar 63 is located inside the pressing shaft 6 so that an elastic unit 62 is placed inside the hollow bar 63. An elastic cap 65 is located on a top section of the pressing shaft 6, wherein a combination of the elastic cap 65 and the pressing shaft 6, the elastic unit 62 located inside the hollow bar 63 can allow the holder 1 to rotate 360 degree in a horizontal axis.

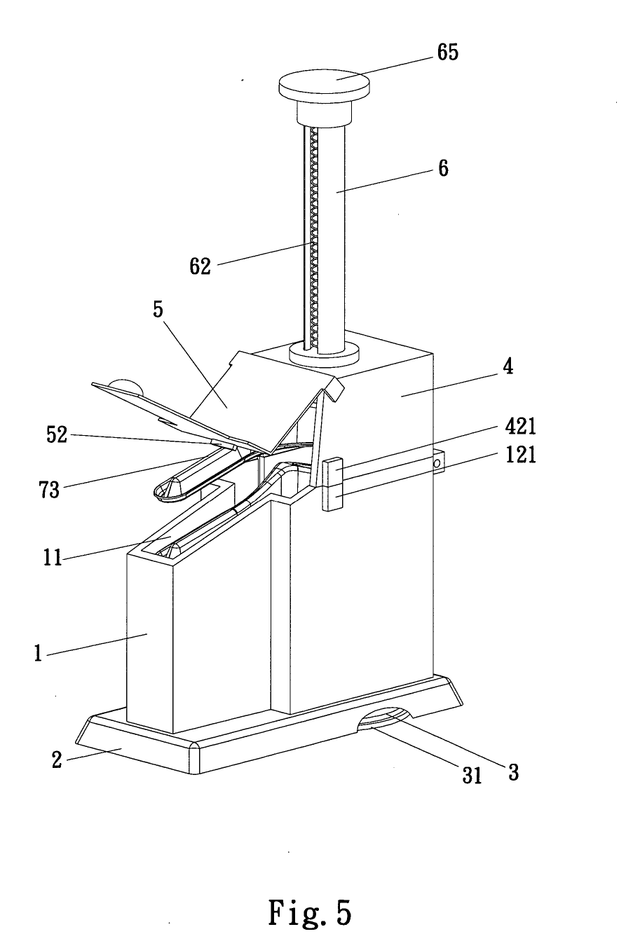

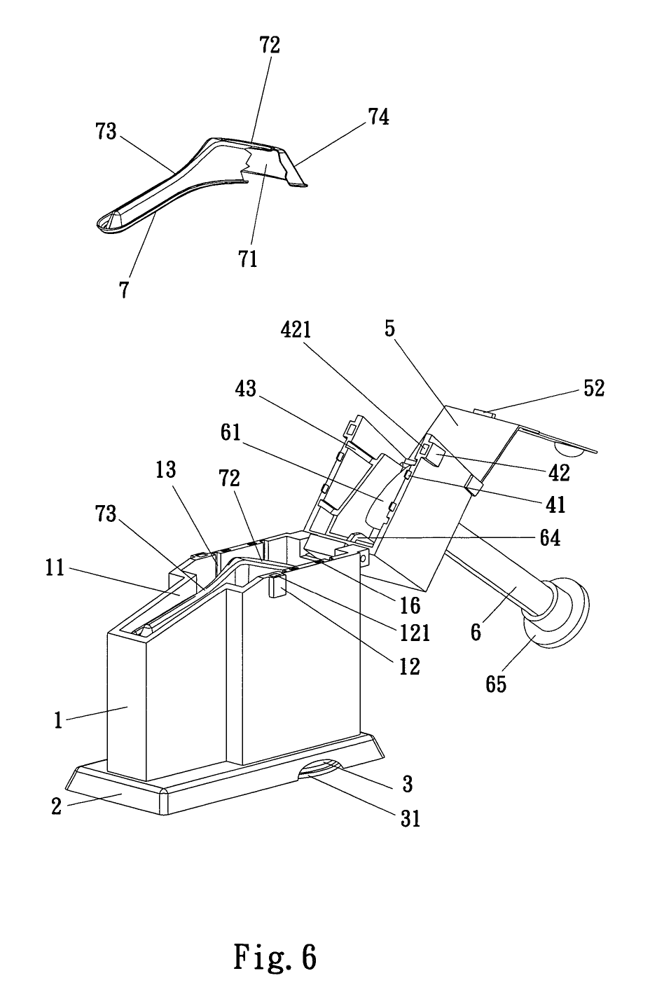

Refer to FIGS. 5, 6,7 and 8 showing, a diagram of showing how the device of drawing cutlery is utilized by opening a cover body automatically in accordance with a preferred example, a diagram of showing how the device of drawing cutlery is utilized by removing the top portion of the device in accordance with another preferred embodiment, a cross-sectional view of one of designs of a device of drawing cutlery of a preferred embodiment of the present invention, and another cross-sectional view of another designs of a device of drawing cutlery of another preferred embodiment of the present invention.

When the device of drawing cutlery is in use, the device is placed on a level surface, such as on a desk's surface. Hen the device of the drawing cutlery of the present invention is pressed slightly, a second sucking plate 31 located inside the rotating unit 3 is adhered onto the surface of the desk, the cover body 5 and the connecting stand 4 can be opened. A plurality of disposable spoons are inserted into a space 11 of the holder 1 with their backsides facing the on the top. A front end of the scoop 71 of the last disposable spoon 7 is located firmly on the protruding body 22 at a central part of the stand unit 2. The connecting stand 4 and the cover body 5 are then put onto the holder 1, wherein the magnets 121 locating at both sides of the top portion of the holder are magnetically connected to the magnet plates 421 positioning at both sides of the bottom portion of the connecting stand 4. To remove the disposable spoon 7, the elastic cap 65 of the pressing shaft 6 is pressed down slightly, the first sucking plate 61 locating at the bottom portion of the pressing shaft 6 will suck on the backside of the scoop 72 of the very first disposable spoon 7. When the pressing shaft is pressed down, the elastic unit 62 is compressed, once the pressing force on the pressing shaft is released, the elastic unit 62 locating in the pressing shaft 6 will release its elastic force. This elastic force from the elastic unit 62 will move the first disposable spoon 7 upwards, when the disposable spoon 7 is moving upwards, end of the backside 73 of the disposable spoon 7 will push the cover protruding point 52 of the cover body 5 as a result, the cover body 5 is automatically opened. When the cover body 5 is opened, the cover body 5 and the weight block will utilize the cover protruding point 52 to press down the backside 73 of the disposable spoon 7. The front side 74 of the disposable spoon 7 is already located firmly by the pressing protruding point 64, the pressing force causes the shape of the disposable spoon 7 to bent and induce falling off effect. Thus, the disposable spoon 7 can be retrieved every signal time from the device. The device of the present invention provides a structure that can keep the cutlery hygienic clear and the disposable cutlery can be retrieved easily by the user. The weight block located at the front end of the cover body 5 and its won weight of the cover body 5 induce the cover body 5 to shut down automatically. Therefore, the disposable cutlery located inside the holder 1 can be kept clear. Further, the design of the rotating unit 3 located at the bottom portion of the device 1, can provide the device to rotate 360 degree along the horizontal axis, so that the user can convenient retrieve the disposable cutlery or spoon from any direction or location.

Other embodiments of the invention will appears to those skilled in the art from consideration of the specification and practice of the invention disclosed herein. It is intended that the specification and examples to be considered as exemplary only, with a true scope and spirit of the invention being indicated by the following claims

What is claim is:

1. A device of storing cutlery, comprising:
a holder, having a containing space inside the holder and a moving device locating on the holder, wherein the moving device of the holder has a connecting stand, a pressing guiding holes are located at a central portion of the connecting stand, and a cover is utilized to cover the holder is formed on one side of the connecting stand is part of the moving device;
a pressing shaft, locating between the holder and the connecting stand and is part of the moving device, an elastic unit is located between the pressing shaft and the connecting stand, a first sucking plate is formed on one end of the pressing shaft.

2. The device of claim 1, wherein at least one fixing hole locating at one side of the holder is utilized to integrate with a connecting shaft and the connecting stand.

3. The device of claim 1, wherein holder channels are formed on both sides of the holder and are corresponding to the both sides of the pressing shaft.

4. The device of claim 1, wherein magnetic devices are located between the holder and the connecting stand in order to achieve open and close the connecting stand.

5. The device of claim 4, wherein magnets located inside a magnetic slot of a side surface of the holder is magnetically connected to a magnet plate located inside a magnetic plate slot at a side surface of the connecting stand.

6. The device of claim 1, wherein a positioning slot locating at one side of the holder is connected to and corresponding to a positioning protrusion locating one side of the connecting stand.

7. The device of claim 1, wherein trenches are formed on inside surface of the connecting stand, a connecting part of the connecting stand and the holder comprises fixing holes, and cover fixing holes are formed a connecting part of the connecting cover and the cover.

8. The device of claim 1, wherein cover fixing bar are formed on a connecting part of the cover and the connecting stand, a weight block is located on a suitable position of the cover.

9. The device of claim 1, wherein a stand unit is formed at a bottom part of the holder, a protrusion is formed at a central part of the stand unit, a fixing hole is formed at the central portion of the protrusion, the fixing hole, a fixing device and a plate are utilized to locate a second sucking plate, a rotating stand is formed between the stand unit and the second sucking plate.

10. The device of claim 9, wherein a sucking bar is formed on the second sucking plate, a screw is utilized together with the fixing device to position the second sucking plate.

11. The device of claim 1, wherein protruding bars are formed at side surfaces of the connecting stand and the holder and both sides of a bottom portion of the pressing shaft.

12. The device of claim 1, wherein affixing bar is formed on a central part of one end of the pressing shaft and is utilized to integrated with a fixing hole of the first sucking plate.

13. The device of claim 1, wherein a hollow bar is located at the central part of the pressing shaft, an elastic device can be inserted inside the hollow bar, an elastic cap is located inside one end of the pressing shaft to firmly position the elastic device.

14. The device of claim 1, wherein a pressing protruding point is formed on one side of the pressing shaft.
